(19) United States
(12) Patent Application Publication
(10) Pub. No.: US 2025/0191107 A1
(43) Pub. Date: Jun. 12, 2025

(54) IMAGE PROCESSING METHOD, SYSTEM-ON-CHIP, AND IMAGE PROCESSING DEVICE INCLUDING THE SAME

(71) Applicant: SAMSUNG ELECTRONICS CO., LTD., Suwon-si (KR)

(72) Inventors: Jun-Shik Jeon, Suwon-si (KR); Sungho Roh, Suwon-si (KR); Jungyeop Yang, Suwon-si (KR); Jongseong Choi, Suwon-si (KR)

(21) Appl. No.: 18/767,375

(22) Filed: Jul. 9, 2024

(30) Foreign Application Priority Data
Dec. 8, 2023 (KR) 10-2023-0177800

(51) Int. Cl. G06T 1/20; G06F 9/48; G06T 1/60

(52) U.S. Cl. CPC G06T 1/20; G06T 1/60; G06F 9/4812

(57) ABSTRACT

An example image processing method includes performing an image processing operation with respect to a plurality of input data stored in an input data buffer. Based on performing the image processing operation being finished, an interrupt signal is transmitted. The interrupt signal indicates that the image processing operation with respect to the plurality of input data has been finished.

### CROSS-REFERENCE TO RELATED APPLICATION

This application claims priority to and the benefit of Korean Patent Application No. 10-2023-0177800 filed in the Korean Intellectual Property Office on Dec. 8, 2023, the entire contents of which is incorporated herein by reference.

### BACKGROUND

Electronic devices such as smartphones, tablet PCs, laptop/desktop computers, digital cameras, etc. may be equipped with digital video functions. These electronic devices may transmit, receive, encode, decode, and/or store digital video information more efficiently by implementing video compression technology.

As the demand for high-definition video increases, electronic devices will process high amounts of digital video information. Because a lot of power is consumed in encoding or decoding digital video information, reducing the power consumption is desired.

### SUMMARY

The present disclosure relates to an image processing method, a system-on-chip, and an image processing device including the same capable of reducing waiting time after power-ON.

The present disclosure relates to an image processing method, a system-on-chip, and an image processing device including the same capable of reducing power consumption.

In general, according to some aspects, an image processing method includes performing an image processing operation with respect to a plurality of input data stored in an input data buffer, and transmitting an interrupt signal indicating that the image processing operation with respect to the plurality of input data has been finished, when the performing of the image processing operation with respect to the plurality of input data is finished.

In general, according to some aspects, a system-on-chip includes a processor configured to store a plurality of input data in an input data buffer, and a codec configured to perform an image processing operation with respect to the plurality of input data, and when the performing of the image processing operation with respect to the plurality of input data is finished, transmit an interrupt signal indicating that the image processing operation with respect to the plurality of input data has been finished to the processor.

In general, according to some aspects, an image processing device includes a working memory including an input data buffer storing a plurality of input data and an output data buffer storing a plurality of output data, and a system-on-chip configured to store the plurality of input data in the input data buffer, and when the storing of the plurality of input data is finished, perform an image processing operation with respect to the plurality of input data, store the plurality of output data corresponding to the plurality of input data in the output data buffer, and generate an interrupt signal.

### BRIEF DESCRIPTION OF THE DRAWINGS

FIG. 1 is a block diagram of an example of a video coding device including a system-on-chip.

FIG. 2 is a block diagram showing an example of a codec.

FIG. 3 is a diagram showing an example of a working memory.

FIG. 4 is a diagram showing an example of an input data buffer of a working memory.

FIG. 5 is a flowchart showing an example of an image processing method.

FIG. 6 is a flowchart showing an example of an operation method of a processor.

FIG. 7 is a flowchart showing an example of an image processing method.

FIG. 8 is a flowchart showing an example of an operation method of a processor.

FIG. 9 is a flowchart showing an example of an image processing method.

FIG. 10 is a flowchart showing an example of an operation method of a processor.

FIG. 11 is a flowchart showing an example of an image processing method.

### DETAILED DESCRIPTION

Hereinafter, with reference to the accompanying drawings, implementations of the present disclosure will be described in detail so that those skilled in the art can easily carry out the present disclosure. As those skilled in the art would realize, the described implementations may be modified in various different ways, and the present disclosure is not limited to the implementations described herein.

Accordingly, the drawings and description are to be regarded as illustrative in nature and not restrictive. Like reference numerals designate like elements throughout the specification. In the flowchart described with reference to the drawings, the order of operations may be changed, several operations may be merged, a certain operation may be divided, and a specific operation may not be performed.

In addition, expressions described in the singular may be interpreted in the singular or plural unless explicit expressions such as “one” or “single” are used. Terms including ordinal numbers, such as first and second, may be used to describe various components, but the components are not limited by these terms. These terms may be used for the purpose of distinguishing one component from another.

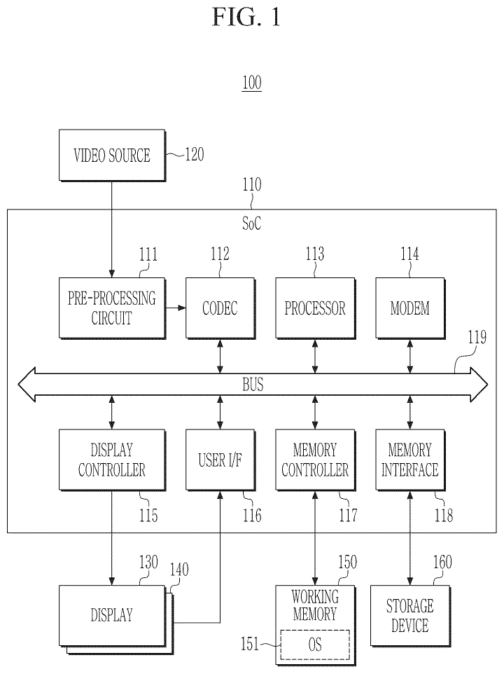

FIG. 1 is a block diagram of an example of a video coding device including a system-on-chip.

Referring to FIG. 1, a video coding device 100 may be implemented as a TV, a digital TV (DTV), an internet protocol TV (IPTV), a set-top box, a personal computer (PC), a laptop/desktop computer, a computer workstation, a smart phone, a tablet PC, a digital camera, a video game platform (or video game console), a server, or the like. The video coding device 100 may refer to various devices capable of processing 2-dimensional (2D) or 3D graphics data and displaying the processed data.

The video coding device 100 may include a system-on-chip (SoC) 110, a video source 120, a display 130, an input device 140, a working memory 150, and a memory interface 118.

The video source 120 may be implemented as a camera equipped with a CCD or CMOS image sensor. The video source 120 may photograph a subject, generate data for the subject, and provide the generated data to the SoC 110.

The SoC 110 may control an overall operation of the video coding device 100. For example, the SoC 110 may include an integrated circuit (IC), a motherboard, an application processor (AP), or a mobile AP. The SoC 110 may process data output from the video source 120, and may display the processed data through the display 130, store the processed data in a storage device 160, or transmit the processed data to another data processing system. The data output from the video source 120 may be transmitted to a pre-processing circuit 111 through MIPI® camera serial interface (CSI).

The SoC 110 may include the pre-processing circuit 111, a codec 112, a processor 113, a modem 114, a display controller 115, a user interface 116, a memory controller 117, the memory interface 118, and a bus 119.

The codec 112, the processor 113, the modem 114, the display controller 115, the user interface 116, the memory controller 117, and the memory interface 118 may send data to or receive data from each other through the bus 119. For example, the bus 119 may be implemented as at least one selected from a peripheral component interconnect (PCI) bus, a PCI express (PCIe) bus, an Advanced Microcontroller Bus Architecture (AMBA), an advanced high-performance bus (AHB), an advanced peripheral bus (APB), an Advanced extensible Interface (AXI) bus, and a combination thereof, but is not limited thereto.

The pre-processing circuit 111 may receive data output from the video source 120. The pre-processing circuit 111 may process the received data, and output data generated according to the processing result to the codec 112. The pre-processing circuit 111 may be implemented as, for example, an image signal processor (ISP). FIG. 1 illustrates that that the pre-processing circuit 111 is implemented within the SoC 110, but the pre-processing circuit 111 may be implemented outside the SoC 110.

The codec 112 may perform an encoding (or encrypting) operation with respect to data processed in the pre-processing circuit 111. The codec 112 may perform decoding (or decrypting) operation with respect to data provided from the processor 113 or stored in the working memory 150. The encoding/decoding operation may use encoding/decoding technologies such as Joint Photographic Experts Group (JPEG), Moving Picture Experts Group (MPEG), MPEG-2, MPEG-4, VC-1, VP9, AV1, H.264, H.265, High Efficiency Video Coding (HEVC), or the like, but is not limited thereto. The codec 112 may be implemented as a hardware codec or software codec. Hereinafter, although an image processing operation of the codec 112 is described taking an example of a decoding operation, the image processing operation may include an encoding operation, and the image data processing method may be applied to both of the decoding operation and the encoding operation.

The codec 112 may read input data for reading data (i.e., an encoded bitstream of video data) stored in the working memory 150 from the working memory 150. The codec 112 may decode the encoded bitstream, and may store a decoded picture in a DPB within the working memory 150. In some implementations, the codec 112 may receive information with respect to the number of the input data, and may read the input data from the working memory 150 based on the number of the input data.

The codec 112 may store the decoded picture in the DPB, and may transmit an interrupt signal to the processor 113. In some implementations, the codec 112 may finish decoding of a plurality of input data, and may transmit the interrupt signal to the processor 113.

The processor 113 may control an operation of the SoC 110. The processor may run software (application programs, operation systems, device drivers). The processor 113 will run an operation system OS loaded in the working memory 150. The processor 113 will run various application programs to be run based on the operation system OS. The processor 113 may be provided as a homogeneous multi-core processor or a heterogeneous multi-core processor.

In some implementations, the processor 113 may write the plurality of input data in the working memory 150, and may supply power to the codec 112. For example, the processor 113 may finish writing of the input data in the working memory 150, and may transmit a power-ON signal to the codec 112. The processor 113 may supply power to the codec 112, and may transmit information on the number of the plurality of input data written in the working memory 150 to the codec 112. For example, the processor 113 may transmit the interrupt signal including the information on the number of the plurality of input data to the codec 112. In some implementations, the processor 113 may supply power to the codec 112, and may write the plurality of input data.

The processor 113 may receive the interrupt signal from the codec 112, and may stop supplying of power to the codec 112. For example, upon receiving the interrupt signal from the codec 112, the processor 113 may transmit a power-OFF signal to the codec 112. In some implementations, when the number of the interrupt signals received from the codec 112 is equal to the number of the plurality of input data, the processor 113 may transmit the power-OFF signal to the codec 112.

The modem 114 may output data encoded by the codec 112 or the processor 113 to the outside by using wireless communication technology. The modem 114 may be configured as a one-directional communication interface or bidirectional communication interface, and for example, may be configured to send or receive message for establishing connection, and verify and exchange any other information related to data transmission such as communication link and/or encoded data transmission.

The display controller 115 may transmit data output from the codec 112 or the processor 113 to the display 130. The display controller 115 may transmit data to the display 130 through a MIPI display serial interface (DSI). The display 130 may be any type of display such as for example, an integrated or external display or monitor, which is configured to show the decoded picture, or include such a display. For example, display may include liquid-crystal display (LCD), organic light-emitting diode (OLED) display, plasma display, projector, micro LED display, liquid crystal on silicon (LCoS), digital light processor (DLP), or any other types of display.

The input device 140 may receive a user input from a user, and may transmit an input signal in response to the user manipulation to the user interface 116. The input device 140 may be implemented as a touch panel, a touch screen, a voice recognizer, a touch pen, a keyboard, a mouse, a track point, or the like, but is not limited thereto. For example, when the input device 140 is a touch screen, the input device 140 may include a touch panel and a touch panel controller. In addition, when the input device 140 is a voice recognizer, the input device 140 may include a voice recognition sensor and a voice recognition controller. The input device 140 may be connected to the display 130, and may be implemented to be separated from the display 130.

The user interface 116 may receive input signal from the input device 140, and may transmit data generated by the input operation to the processor 113.

Under the control of the codec 112 or the processor 113, the memory controller 117 may read data stored in a working memory 150, and transmit the read data to the codec 112 or the processor 113. In addition, under the control of the codec 112 or the processor 113, the memory controller 117 may write data output from the codec 112 or the processor 113 in the working memory 150.

The working memory 150 may receive and store data encoded and/or decoded by the codec 112. In addition, the working memory 150 may transmit the stored data to the processor 113 or the modem 114.

The working memory 150 may be implemented as a volatile memory. The volatile memory may be implemented as random-access memory (RAM), static RAM (SRAM), dynamic RAM (DRAM), synchronous DRAM (SDRAM), thyristor RAM (T-RAM), zero capacitor RAM (Z-RAM), or twin transistor RAM (TTRAM).

The memory interface 118 may access the storage device 160 according to the request of the processor 113. That is, the memory interface 118 may provide an interface between system-on-chip (SoC) and the storage device 160. For example, data processed by the processor 113 is stored in the storage device 160 through the memory interface 118. As another example, data stored in the storage device 160 may be provided to the processor 113 through the memory interface 118.

The storage device 160 may be provided as a storage medium of the video coding device 100. The storage device 160 may store user data, operation system (OS) images, application programs, or the like. The storage device 160 may be implemented as a non-volatile memory.

The non-volatile memory may be implemented as electrically erasable programmable read-only memory (EEPROM), flash memory, magnetic RAM (MRAM), spin-transfer torque MRAM, ferroelectric RAM (FeRAM), phase change RAM (PRAM), or resistive RAM (RRAM). In addition, non-volatile memory may be implemented as multimedia card (MMC), embedded MMC (eMMC), universal flash storage (UFS), solid-state drive (or solid-state disk) (SSD), USB flash drive, or hard disk drive (HDD).

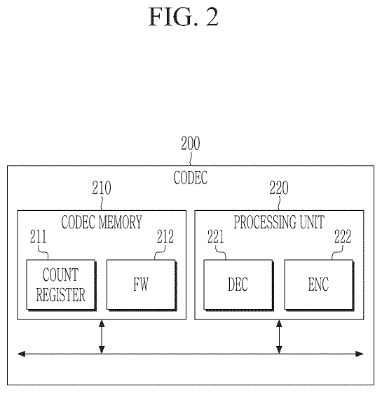

FIG. 2 is a block diagram showing an example of a codec.

Referring to FIG. 2, a codec 200 may decode the encoded bitstream to restore the decoded picture, and may encode the picture to generate the encoded bitstream. A codec 200 may include a codec memory 210 and a processing unit 220.

The codec memory 210 may be a write buffer or read buffer configured to temporarily store data input to the codec 200. The codec memory 210 may be configured to store various information necessary for the codec 200 to operate. For example, the codec memory 210 may store software, firmware, or information related to encoding and decoding operations. In some implementations, the codec memory 210 may be SRAM, but the present disclosure is not limited thereto, and the codec memory 210 may be implemented as various types of memory devices such as DRAM, MRAM, PRAM, or the like. For brevity of drawings and convenience of explanation, FIG. 2 illustrates that the codec memory 210 is included in the codec 200, but the present disclosure is not limited thereto. The codec memory 210 may be located outside the codec 200, and the codec 200 may communicate with the buffer memory through a separate communication channel or interface.

The codec memory 210 may include a count resistor 211. The count resistor 211 may include an input count resistor referenced to read the input data and an output count resistor referenced to store the output data. In some implementations, when the input data is written in the working memory, a count value of the input count resistor may be increased. For example, the processor 113 may store the input data in the working memory 150, and may change value of the input count resistor of the codec 200. The codec 200 may determine an address of the working memory 150 with reference to the count value of the input count resistor, and may read the input data stored in the determined address. In some implementations, the output count resistor may count the number of times of decodes. When the codec 200 finishes decoding of the encoded bitstream, the output count resistor may increase the number of times of decodes. The codec 200 may count value of determine the address of the working memory 150 with reference to the output count resistor, and may write the output data related to the decoded picture in the determined address.

Firmware 212 may be loaded in the codec memory 210. The firmware 212 may transfer the pre-processed picture data and the encoded bit stream to the processing unit 220. For example, when the codec 200 receives the interrupt signal from the processor 113, the firmware 212 may read the input data stored in the working memory 150 by the processor 113. In some implementations, the firmware 212 may receive information on the number of the input data from the processor 113, and may read the input data stored in the working memory 150 by the processor 113 based on the number of the input data. The firmware 212 may transfer the encoded bitstream read based on the input data to the processing unit 220.

The codec memory 210 may include a special function register (SFR). The special function register may be used to decode the encoded bitstream in an interlaced scan method.

The processing unit 220 may include a decoder 221 configured to decode the encoded bitstream transferred from the firmware 212 and an encoder 222 configured to encode the pre-processed picture data.

The decoder 221 may receive the encoded bitstream, and may provide the decoded picture. The encoder 222 (also referred to as a video encoder) may receive the pre-processed picture data, and process the pre-processed picture data to provide the encoded bitstream.

Each of the decoder 221 and the encoder 222 may be implemented as various appropriate circuits, for example, one or more microprocessors, digital signal processors (DSPs), application-specific integrated circuits (ASICs), field-programmable gate arrays (FPGAs), discrete logic, hardware, or a combination thereof. When this technique is implemented in part by using software, the device may store software instructions in a suitable non-transitory computer-readable storage medium and execute the instructions using hardware, such as one or more processors, to perform the techniques of the present disclosure. Any of the foregoing (including hardware, software, combinations of hardware and software, or the like) may be considered one or more processors.

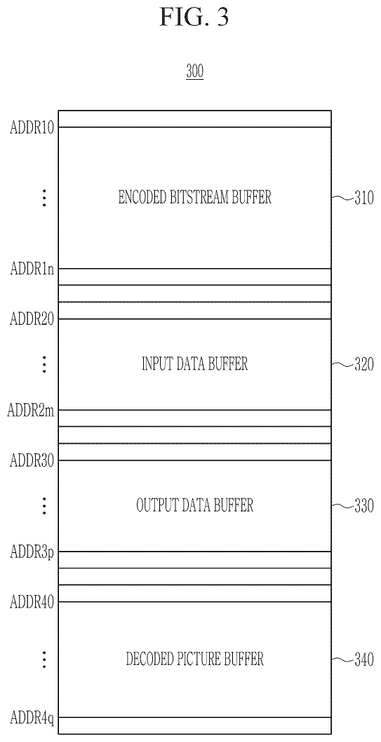

FIG. 3 is a diagram showing an example of a working memory.

Referring to FIG. 3, the working memory 300 may include a plurality of buffer areas 310, 320, 330, and 340. The encoded bitstream may be stored in a first region 310. The input data may be stored in a second region 320. The output data may be stored in a third region 330. The decoded picture may be stored in a fourth region 340. First to fourth regions 310, 320, 330, and 340 may be discontinuously arranged within the working memory 300, and the size of each region may be set in various ways. Hereinafter, each of the first to fourth regions 310, 320, 330, and 340 will be referred to as the encoded bitstream buffer, an input data buffer, an output data buffer, and the decoded picture buffer.

In some implementations, an operation system 151 may allocate address ranges ADDR10 to ADDR1n within the working memory 300 to the first region 310, allocate address ranges ADDR20 to ADDR2m to the second region 320, allocate address ranges ADDR30 to ADDR3p to the third region 330, and allocate address ranges ADDR40 to ADDR4q to the fourth region 340. The first region 310 may include a plurality of encoded bitstream buffer areas within the address ranges ADDR10 to ADDR1n. The second region 320 may include a plurality of input data buffer areas within the address ranges ADDR20 to ADDR2m. The third region 330 may include a plurality of output data buffer areas within the address ranges ADDR30 to ADDR3p. The fourth region 340 may include a plurality of DPB regions within the address range ADDR40 to ADDR4q.

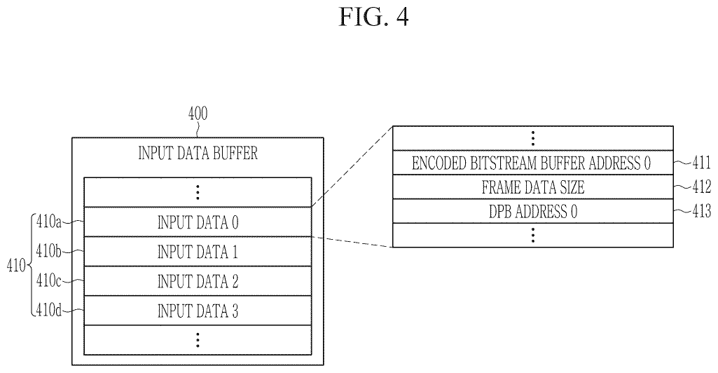

FIG. 4 is a diagram showing an example of an input data buffer of a working memory.

Referring to FIG. 4, an input data buffer 400 may include the plurality of input data 410. One input data 410a may include information on the encoded bitstream buffer address 411, frame data size 412, and a DPB address 413. The input data 410 may be generated by the processor 113. The processor 113 may receive an allocation of the DPB in which the encoded bitstream data is to be stored by the operation system 151, and generate the input data 410 including information on the DPB address 413 indicating the allocated DPB.

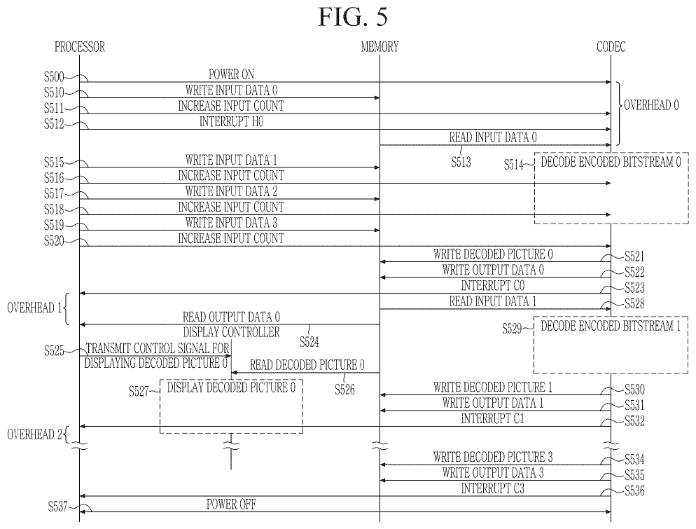

FIG. 5 is a flowchart showing an example of an image processing method.

Referring to FIG. 1 to FIG. 5, at step S500, the processor 113 may transmit the power-ON signal to the codec 112. The codec 112 may receive the power-ON signal, and may receive power.

At step S510, the processor 113 may store an input data INPUT DATA 0 in an input data buffer 320 of the working memory 300. The processor 113 may generate the input data INPUT DATA 0 including the address of the encoded bitstream buffer 310 storing the encoded bitstream, the size of the encoded bitstream, and the DPB address.

At step S511, the input data INPUT DATA 0 is stored, and then the processor 113 may increase a value of the count resistor 211 of the codec 112.

At step S512, the processor 113 may transmit an interrupt signal INTERRUPT HO, after increasing the count resistor 211 of the codec 112. The processor 113 may generate the interrupt signal INTERRUPT HO indicating start of decoding.

At step S513, the codec 112 may receive the interrupt signal INTERRUPT HO, and may read the input data INPUT DATA 0 from an input data buffer of the working memory 300 based on the count resistor 211. Before the step S513, the codec 112 may receive the address range of the input data buffer from the processor 113. The codec 112 may receive the interrupt signal INTERRUPT HO for the first time, and when the value of the count resistor 211 is changed, may read the input data INPUT DATA 0 from the base address of the input data buffer.

At step S514, the codec 112 may decode the encoded bitstream ENCODED BITSTREAM 0 stored in the encoded bitstream buffer address with reference to the input data INPUT DATA 0. The codec 112 may read the encoded bitstream ENCODED BITSTREAM 0 from the working memory 300 based on the encoded bitstream buffer address included in the input data INPUT DATA 0, and may decode the encoded bitstream ENCODED BITSTREAM 0 to generate the decoded picture DECODED PICTURE 0.

At step S515, S517, and S519, the processor 113 may store the plurality of input data INPUT DATA 1, 2, and 3 in the input data buffer 320 of the working memory 300, and at step S516, S518, and S520, may increase the value of the count resistor 211 of the codec 112.

The processor 113 may generate the plurality of input data INPUT DATA 1, 2, and 3 corresponding to a plurality of encoded bitstreams. The processor 113 may store the plurality of input data INPUT DATA 1, 2, and 3 generated corresponding to the plurality of encoded bitstreams in the input data buffer 320 within the working memory 300.

Whenever the storage of each of the plurality of input data INPUT DATA 1, 2, and 3 is finished, or when the storage of a preset quantity of input data is finished, the processor 113 may increase the value of the count resistor 211 of the codec 112.

At step S521, the codec 112 may write the decoded picture DECODED PICTURE 0 to a DPB 340, with reference to the input data INPUT DATA 0. The codec 112 may write the decoded picture DECODED PICTURE 0 in the working memory 300 based on the DPB address included in the input data INPUT DATA 0.

At step S522, the codec 112 may write an output data OUTPUT DATA 0 related to the decoded picture DECODED PICTURE in an output data buffer 330. When the decoding is finished for the first time, the codec 112 may write the output data in a base address of the output data buffer 330.

At step S523, when writing of the output data is finished, the codec 112 may transmit an interrupt signal INTERRUPT C0 to the processor 113.

At step S524, the processor 113 may receive the interrupt signal INTERRUPT C0, and read the output data OUTPUT DATA 0 from the output data buffer 330. In some implementations, the processor 113 may determine the address storing the output data OUTPUT DATA 0 within the output data buffer 330 based on the number of times of reception of the interrupt signal INTERRUPT C0. The processor 113 may read the output data OUTPUT DATA 0 from the determined address.

At step S525, the processor 113 may transmit a control signal for displaying the decoded picture DECODED PICTURE 0 to the display controller 115. The control signal may include the DPB address determined based on the output data OUTPUT DATA 0.

At step S526, the display controller 115 may read the decoded picture DECODED PICTURE 0 stored in the DPB 340.

At step S527, the display controller 115 may display the decoded picture DECODED PICTURE 0 on the display 130.

At step S528, after transmitting the interrupt signal INTERRUPT C0, the codec 112 may read an input data INPUT DATA 1 from the input data buffer. When the decoding is finished, the codec 112 may read the input data INPUT DATA 1 from a subsequent address of the base address of the input data buffer (i.e., an address obtained by adding the base address to the value obtained by multiplying the number of times of finishing decoding and the offset address size).

At step S529, the codec 112 may decode the encoded bitstream ENCODED BITSTREAM 1 stored in the encoded bitstream buffer address with reference to the input data INPUT DATA 1. The codec 112 may read the encoded bitstream ENCODED BITSTREAM 1 from the working memory 300 based on the encoded bitstream buffer address included in the input data INPUT DATA 1, and may decode the encoded bitstream ENCODED BITSTREAM 1 to generate the decoded picture DECODED PICTURE 1.

At step S526, the codec 112 may write the decoded picture DECODED PICTURE 1 to the DPB 340, with reference to the input data INPUT DATA 1. The codec 112 may write the decoded picture DECODED PICTURE 10 in the DPB 340 based on the DPB address included in the input data INPUT DATA 1.

At step S531, the codec 112 may write an output data OUTPUT DATA 1 related to the decoded picture DECODED PICTURE 1 in the output data buffer 330. The codec 112 may write the output data OUTPUT DATA 1 to an address subsequent the base address of the output data buffer 330.

At step S532, when writing of the output data OUTPUT DATA 1 is finished, the codec 112 may transmit an interrupt signal INTERRUPT C1 to the processor 113.

In the same way, the codec 112 may perform decoding with respect to the input data INPUT DATA 2 and 3, and may store the decoded pictures in the DPB 340.

At step S534, the codec 112 may store the decoded picture DECODED PICTURE 3 in the DPB 340 based on the last input data INPUT DATA 3.

At step S535, the codec 112 may write an output data OUTPUT DATA 3 related to the decoded picture DECODED PICTURE 3 in the output data buffer 330.

At step S536, when writing of the output data OUTPUT DATA 3 is finished, the codec 112 may transmit an interrupt signal INTERRUPT C3 to the processor 113.

At step S537, the processor 113 may transmit the power-OFF signal to the codec 112. In some implementations, when the number of the interrupt signals C0, C1, . . . , C3 received from the codec 112 is equal to the number of the input data INPUT DATA 0, 1, 2, and 3, the processor 113 may transmit the power-OFF signal to the codec 112. That is, when the decoding based on the input data INPUT DATA 0, 1, 2, and 3 is finished, the processor 113 may transmit the power-OFF signal to the codec 112.

Since the processor 113 applies the power-ON signal to the codec 112 before writing the input data INPUT DATA 0 in the input data buffer 320, a waiting time OVERHEAD 0 after the codec 112 is powered on and until the input data INPUT DATA 0 is read may be generated. Since the processor 113 receives and processes the interrupt signals INTERRUPT C0, C1, . . . , and C3 due to finishing of the decoding from the codec 112, power consumption OVERHEAD 1 and 2 due to transmission and reception of the interrupt signal may be generated.

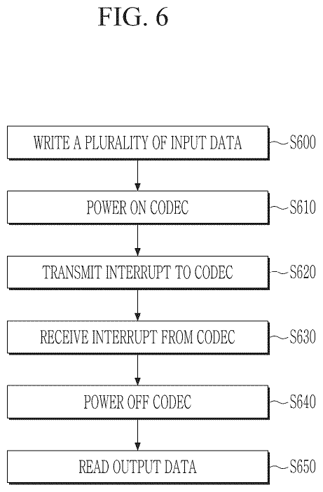

FIG. 6 is a flowchart showing an example of an operation method of a processor.

At step S600, referring to FIG. 1 to FIG. 4 and FIG. 6, the processor 113 may write the plurality of input data in the working memory 150. The processor 113 may store the plurality of input data corresponding to the plurality of encoded bitstreams in the input data buffer 320.

At step S610, the processor 113 may supply power to the codec 112. For example, the processor 113 may finish writing of the input data in the working memory 150, and may transmit the power-ON signal to the codec 112.

At step S620, the processor 113 may transmit the interrupt signal to the powered-on codec 112. In some implementations, the interrupt signal may include the information on the number of the plurality of input data stored in the working memory 150. In some implementations, the processor 113 may transmit data including the information on the number of the plurality of input data as well as the interrupt signal to the codec 112. In some implementations, the processor 113 may store the plurality of input data in the input data buffer of the working memory, and may increase the value of the count resistor 211 of the codec 112.

At step S620, the processor 113 may receive the interrupt signal from the codec 112. The codec 112 may generate one interrupt signal in response to the plurality of input data. The processor 113 may receive the interrupt signal indicating that the decoding based on the plurality of input data has been finished from the codec 112.

At step S640, the processor 113 may stop supplying of power to the codec 112. For example, upon receiving the interrupt signal from the codec 112, the processor 113 may transmit the power-OFF signal to the codec 112. In some implementations, when the number of the interrupt signals received from the codec 112 is equal to the number of the plurality of input data, the processor 113 may transmit the power-OFF signal to the codec 112.

At step S650, the processor 113 may read the output data from the output data buffer 330.

According to some implementations, since the codec 112 is powered-on after the writing of the input data is finished, the waiting time may be decreased, and since the processor 113 receives one interrupt signal from the codec 112, the electrical power consumed to process the interrupt signal may be reduced.

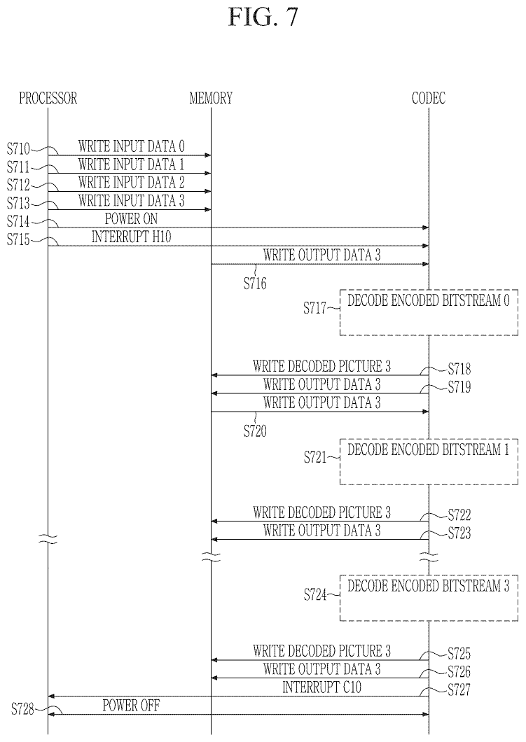

FIG. 7 is a flowchart showing an example of an image processing method.

Referring to FIG. 1 to FIG. 4 and FIG. 7, the processor 113 may store the plurality of input data INPUT DATA 0 to 3 in the working memory 300 at steps S710, . . . , and S713. For example, the processor 113 may store the plurality of input data INPUT DATA 0 to 3 generated corresponding to the plurality of encoded bitstreams in the input data buffer 320 within the working memory 300.

At step S714, when storing the plurality of input data, the processor 113 may transmit the power-ON signal to the codec 112. The codec 112 may receive the power-ON signal, and may receive power. When compared to the example of FIG. 5, in an image processing device according to the present disclosure, since the codec 112 is powered-on after finishing the writing of the plurality of input data INPUT DATA 0 to 3, the waiting time to read the input data INPUT DATA 0 after powering-on the codec 112 may be reduced.

At step S715, the processor 113 may transmit an interrupt signal INTERRUPT H10 to the codec 112. The processor 113 may transmit the interrupt signal INTERRUPT H10 after transmitting the power-ON signal or transmit the interrupt signal INTERRUPT H10 together with the power-ON signal. In some implementations, the interrupt signal INTERRUPT H10 transmitted as the storage of the plurality of input data INPUT DATA 0 to 3 is finished may include the information on the number of the plurality of input data INPUT DATA 0 to 3. In some implementations, the processor 113 may transmit data including the information on the number of the plurality of input data INPUT DATA 0 to 3 as well as the interrupt signal INTERRUPT H10 to the codec 112. In some implementations, the processor 113 may store the plurality of input data INPUT DATA 0 to 3 in the input data buffer 320 of the working memory 300 at steps S710, . . . , and S713, and may increase the value of the count resistor 211 of the codec 112.

At step S716, the codec 112 may read the input data INPUT DATA 0 from the input data buffer of the working memory 300 based on the interrupt signal INTERRUPT H10. Upon receiving the interrupt signal INTERRUPT H10 for the first time, the codec 112 may read the input data INPUT DATA 0 from the base address of the input data buffer.

At step S717, the codec 112 may decode the encoded bitstream ENCODED BITSTREAM 0 stored in the encoded bitstream buffer address with reference to the input data INPUT DATA 0. The codec 112 may read the encoded bitstream ENCODED BITSTREAM 0 from the working memory 300 based on the encoded bitstream buffer address included in the input data INPUT DATA 0, and may decode the encoded bitstream ENCODED BITSTREAM 0 to generate the decoded picture DECODED PICTURE 0.

At step S718, the codec 112 may write the decoded picture DECODED PICTURE 0 to the DPB 340, with reference to the DPB address of the input data INPUT DATA 0. The codec 112 may write the decoded picture DECODED PICTURE 0 in the working memory 300 based on the DPB address included in the input data INPUT DATA 0.

At step S719, the codec 112 may write the output data OUTPUT DATA 0 related to the decoded picture DECODED PICTURE 0 in the output data buffer 330. When the decoding is finished for the first time, the codec 112 may write the output data in the base address of the output data buffer 330.

The when writing of the output data is finished, the codec 112 may not transmit the interrupt signal to the processor 113, but the same as in steps S716 to S719, may read the input data INPUT DATA 1 from the input data buffer at step S720, and may decode the encoded bitstream ENCODED BITSTREAM 1 stored in the encoded bitstream buffer address with reference to the input data INPUT DATA 1 at step S721, may write the decoded picture DECODED PICTURE 1 in the DPB 340 with reference to the input data INPUT DATA 1 at step S722, and may write the output data OUTPUT DATA 1 related to the decoded picture DECODED PICTURE 1 in the output data buffer 330 at step S723. As such, the codec 112 may also perform the decoding operation with respect to the input data INPUT DATA 2 and 3, the same as in steps S716 to S719. The codec 112 may perform the decoding operation as many times as the number of the plurality of input data INPUT DATA 0 to 3.

The codec 112 may decode the encoded bitstream ENCODED BITSTREAM 3 stored in the encoded bitstream buffer address with reference to the last input data INPUT DATA 3 stored in the processor 113 at step S724, may write the decoded picture DECODED PICTURE 3 in the DPB 340 with reference to the input data INPUT DATA 3 at step S725, and may write the output data OUTPUT DATA 3 related to the decoded picture DECODED PICTURE 3 in the output data buffer 330 at step S726.

At step S727, the codec 112 may finish decoding with respect to the plurality of input data INPUT DATA 0 to 3, and transmit an interrupt signal INTERRUPT C10 to the processor 113. In some implementations, the codec 112 may determine whether the decoding with respect to the plurality of input data INPUT DATA 0 to 3 has been finished based on the information on the number of the plurality of input data INPUT DATA 0 to 3. For example, when the number of times of decodes with respect to the plurality of input data INPUT DATA 0 to 3 and the number of the plurality of input data INPUT DATA 0 to 3 are equal to each other, the codec 112 may determine whether the decoding with respect to the plurality of input data INPUT DATA 0 to 3 has been finished, and may generate the interrupt signal INTERRUPT C10. When compared to the example of FIG. 5, in an image processing device according to the present disclosure, since the codec 112 transmits one interrupt signal INTERRUPT C10 after finishing the decoding with respect to the plurality of input data INPUT DATA 0 to 3, the overhead for the processor 113 to process the plurality of interrupt signals INTERRUPT C0 to C3 transmitted by the codec 112 as the decoding of the plurality of input data INPUT DATA 0 to 3 is finished may be reduced.

At step S728, the processor 113 may receive the interrupt signal INTERRUPT C10, and transmit the power-OFF signal to the codec 112.

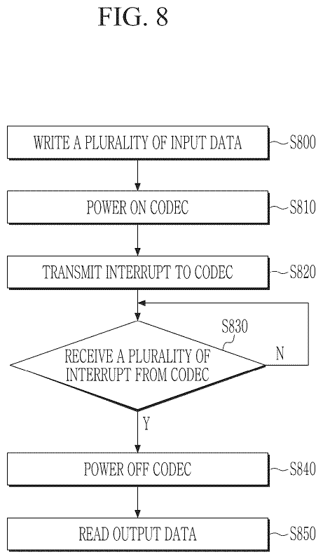

FIG. 8 is a flowchart showing an example of an operation method of a processor.

At step S800, referring to FIG. 1 to FIG. 4 and FIG. 8, the processor 113 may write the plurality of input data in the working memory 150. The processor 113 may store the plurality of input data corresponding to the plurality of encoded bitstreams in the input data buffer 320.

At step S810, the processor 113 may supply power to the codec 112. For example, the processor 113 may finish writing of input data in the working memory 150, and may transmit the power-ON signal to the codec 112.

At step S820, the processor 113 may transmit the interrupt signal to the powered-on codec 112. In some implementations, the interrupt signal may include the information on the number of the plurality of input data stored in the working memory 150. In some implementations, the processor 113 may transmit data including the information on the number of the plurality of input data as well as the interrupt signal to the codec 112. In some implementations, the processor 113 may store the plurality of input data in the input data buffer of the working memory, and may increase the value of the count resistor 211 of the codec 112.

At step S830, the processor 113 may determine whether a plurality of interrupt signals are received from the codec 112. The processor 113 may determine whether the plurality of interrupt signals transmitted by the codec 112 as the decoding of the plurality of input data is finished are received. In some implementations, the processor 113 may compare the number of the plurality of interrupt signals transmitted by the codec 112 and the number of the plurality of input data. When the plurality of interrupt signals are not received from the codec 112, the processor 113 may further receive the interrupt signal.

At step S840, when the reception of the plurality of interrupt signals from the codec 112 is finished, the processor 113 may stop supplying of power to the codec 112. For example, upon receiving the interrupt signal from the codec 112, the processor 113 may transmit the power-OFF signal to the codec 112. In some implementations, when the number of the interrupt signals received from the codec 112 is equal to the number of the plurality of input data, the processor 113 may transmit the power-OFF signal to the codec 112.

At step S850, the processor 113 may read the output data from the output data buffer 330.

According to some implementations, since the codec 112 is powered-on after the writing of the input data is finished, the waiting time may be reduced.

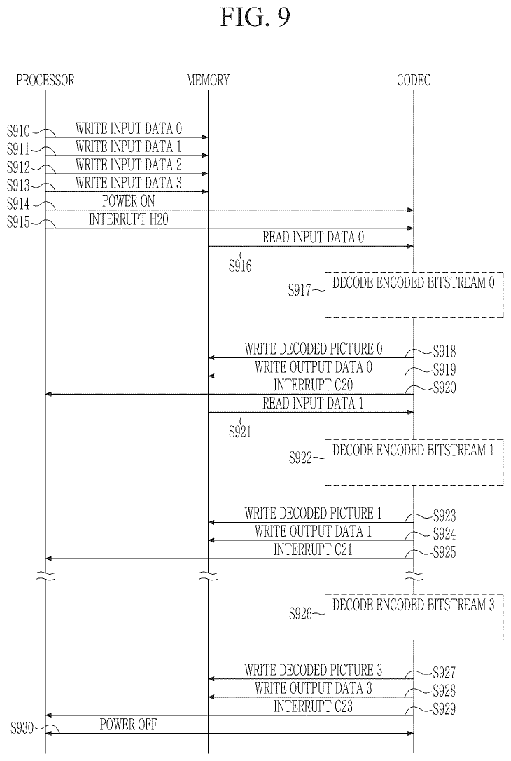

FIG. 9 is a flowchart showing an example of an image processing method.

Referring to FIG. 1 to FIG. 4 and FIG. 9, the processor 113 may store the plurality of input data INPUT DATA 0 to 3 in the working memory 300 at steps S910, . . . , and S913. For example, the processor 113 may store the plurality of input data INPUT DATA 0 to 3 generated corresponding to the plurality of encoded bitstreams in the input data buffer 320 within the working memory 300.

At step S914, when storing the plurality of input data, the processor 113 may transmit the power-ON signal to the codec 112. The codec 112 may receive the power-ON signal, and may receive power. When compared to the example of FIG. 5, in an image processing device according to the present disclosure, since the codec 112 is powered-on after finishing the writing of the plurality of input data INPUT DATA 0 to 3, the waiting time to read the input data INPUT DATA 0 after powering-on the codec 112 may be reduced.

At step S915, the processor 113 may transmit an interrupt signal INTERRUPT H20 to the codec 112. The processor 113 may transmit the interrupt signal INTERRUPT H20 after transmitting the power-ON signal or transmit the interrupt signal INTERRUPT H20 together with the power-ON signal. In some implementations, the interrupt signal INTERRUPT H20 transmitted as the storage of the plurality of input data INPUT DATA 0 to 3 is finished may include the information on the number of the plurality of input data INPUT DATA 0 to 3. In some implementations, the processor 113 may transmit data including the information on the number of the plurality of input data INPUT DATA 0 to 3 as well as the interrupt signal INTERRUPT H20 to the codec 112. In some implementations, the processor 113 may store the plurality of input data INPUT DATA 0 to 3 in the input data buffer 320 of the working memory 300 at steps S910, . . . , and S913, and may increase the value of the count resistor 211 of the codec 112.

At step S916, the codec 112 may read the input data INPUT DATA 0 from the input data buffer of the working memory 300 based on the interrupt signal INTERRUPT H20. Upon receiving the interrupt signal INTERRUPT H20 for the first time, the codec 112 may read the input data INPUT DATA 0 from the base address of the input data buffer.

At step S917, the codec 112 may decode the encoded bitstream ENCODED BITSTREAM 0 stored in the encoded bitstream buffer address with reference to the input data INPUT DATA 0.

At step S918, the codec 112 may write the decoded picture DECODED PICTURE 0 to the DPB 340, with reference to the DPB address of the input data INPUT DATA 0.

At step S919, the codec 112 may write the output data OUTPUT DATA 0 related to the decoded picture DECODED PICTURE 0 in the output data buffer 330.

At step S920, when writing of the output data is finished, the codec 112 may transmit an interrupt signal INTERRUPT C20 to the processor 113. The processor 113 may transmit control signal to the display controller 115 based on the interrupt signal INTERRUPT C20, and accordingly, the display controller 115 may display the decoded picture DECODED PICTURE 0 on the display 130.

After transmitting the interrupt signal INTERRUPT C20, the codec 112 may read the input data INPUT DATA 1 from the input data buffer at step S921, may decode the encoded bitstream ENCODED BITSTREAM 1 stored in the encoded bitstream buffer address with reference to the input data INPUT DATA 1 at step S922, may write the decoded picture DECODED PICTURE 1 in the DPB 340 with reference to the input data INPUT DATA 1 at step S923, may write the output data OUTPUT DATA 1 related to the decoded picture DECODED PICTURE 1 in the output data buffer 330 at step S924, and may transmit an interrupt signal INTERRUPT C21 to the processor 113 at step S925. As such, the codec 112 may also perform the decoding operation with respect to the input data INPUT DATA 2 and 3, the same as in steps S916 to S920.

The codec 112 may decode the encoded bitstream ENCODED BITSTREAM 3 stored in the encoded bitstream buffer address with reference to the last input data INPUT DATA 3 stored in the processor 113 at step S926, may write the decoded picture DECODED PICTURE 3 in the DPB 340 with reference to the input data INPUT DATA 3 at step S927, may write the output data OUTPUT DATA 3 related to the decoded picture DECODED PICTURE 3 in the output data buffer 330 at step S928, and may transmit the interrupt signal INTERRUPT C21 to the processor 113 at step S929,

At step S930, the processor 113 may receive an interrupt signal INTERRUPT C23 transmitted by the codec 112 as the decoding of the last input data INPUT DATA 3 is finished, and may transmit the power-OFF signal to the codec 112.

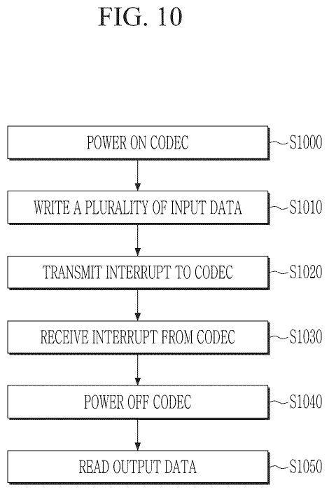

FIG. 10 is a flowchart showing an example of an operation method of a processor.

Referring to FIG. 1 to FIG. 4 and FIG. 10, at step S1000, the processor 113 may supply power to the codec 112.

The processor 113 may write the plurality of input data in the working memory 150 at step S1010, and transmit the interrupt signal to the codec 112 at step S1020. The processor 113 may store the plurality of input data corresponding to the plurality of encoded bitstreams in the input data buffer 320, and when the storage of one input data is finished, may transmit the interrupt signal to the powered-on codec 112.

At step S1030, the processor 113 may receive the interrupt signal from the codec 112. The processor 113 may receive the interrupt signal indicating that the decoding based on the plurality of input data has been finished from the codec 112.

At step S1040, the processor 113 may stop supplying of power to the codec 112. For example, upon receiving the interrupt signal from the codec 112, the processor 113 may transmit the power-OFF signal to the codec 112. In some implementations, when the number of the interrupt signals received from the codec 112 is equal to the number of the plurality of input data, the processor 113 may transmit the power-OFF signal to the codec 112.

At step S1050, the processor 113 may read the output data from the output data buffer 330.

According to some implementations, since the processor 113 receives one interrupt signal from the codec 112, the electrical power consumed to process the interrupt signal may be reduced.

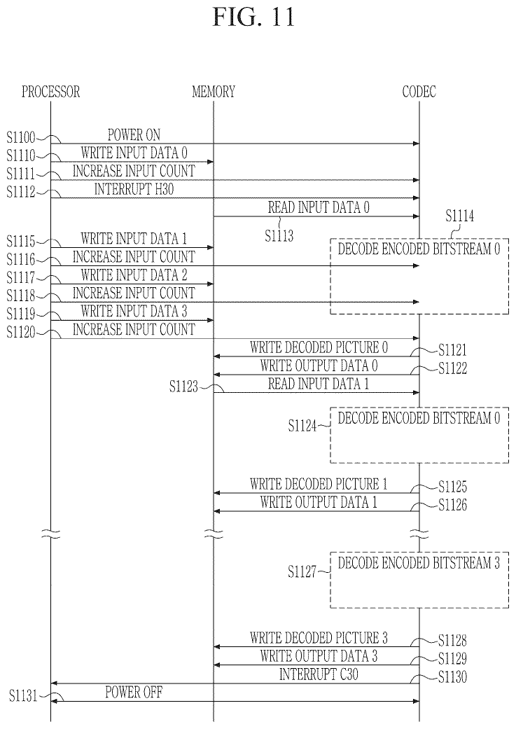

FIG. 11 is a flowchart showing an example of an image processing method.

Referring to FIG. 1 to FIG. 4 and FIG. 11, at step S1100, the processor 113 may transmit the power-ON signal to the codec 112. The codec 112 may receive the power-ON signal, and may receive power.

At step S1110, the processor 113 may store the input data INPUT DATA 0 in the input data buffer 320 of the working memory 300. The processor 113 may generate the input data INPUT DATA 0 including the address of the encoded bitstream buffer 310 storing the encoded bitstream, the size of the encoded bitstream, and the DPB address.

At step S1111, the input data INPUT DATA 0 may be stored, and the processor 113 may increase the value of the count resistor 211 of the codec 112.

At step S1112, after increasing the value of the count resistor 211 of the codec 112, the processor 113 may transmit an interrupt signal INTERRUPT H30.

At step S1113, the codec 112 may read the input data INPUT DATA 0 from the input data buffer of the working memory 300 based on the interrupt signal INTERRUPT H30. Before the step S1113, the codec 112 may receive the address range of the input data buffer from the processor 113. Upon receiving the interrupt signal INTERRUPT H30 for the first time, the codec 112 may read the input data INPUT DATA 0 from the base address of the input data buffer through the value of the count resistor 211.

At step S1114, the codec 112 may decode the encoded bitstream ENCODED BITSTREAM 0 stored in the encoded bitstream buffer address with reference to the input data INPUT DATA 0. The codec 112 may read the encoded bitstream ENCODED BITSTREAM 0 from the working memory 300 based on the encoded bitstream buffer address included in the input data INPUT DATA 0, and may decode the encoded bitstream ENCODED BITSTREAM 0 to generate the decoded picture DECODED PICTURE 0.

The processor 113 may store the plurality of input data INPUT DATA 1, 2, and 3 in the input data buffer 320 of the working memory 300, at steps S1115, S1117, and S1119, and may increase the value of the count resistor 211 of the codec 112, at steps S1116, S1118, and S1120,

At step S1118, the codec 112 may write the decoded picture DECODED PICTURE 0 to the DPB 340, with reference to the DPB address of the input data INPUT DATA 0. The codec 112 may write the decoded picture DECODED PICTURE 0 in the working memory 300 based on the DPB address included in the input data INPUT DATA 0.

At step S1119, the codec 112 may write the output data OUTPUT DATA 0 related to the decoded picture DECODED PICTURE 0 in the output data buffer 330. When the decoding is finished for the first time, the codec 112 may write the output data in the base address of the output data buffer 330.

When writing of the output data is finished, the codec 112 may not transmit the interrupt signal to the processor 113, but the same as in steps S1113 to S1122, may read the input data INPUT DATA 1 from the input data buffer at step S1123, may decode the encoded bitstream ENCODED BITSTREAM 1 stored in the encoded bitstream buffer address with reference to the input data INPUT DATA 1 at step S1124, may write the decoded picture DECODED PICTURE 1 in the DPB 340 with reference to the input data INPUT DATA 1 at step S1125, and may write the output data OUTPUT DATA 1 related to the decoded picture DECODED PICTURE 1 in the output data buffer 330 at step S1126. As such, the codec 112 may also perform the decoding operation with respect to the input data INPUT DATA 2 and 3, the same as in steps S1113 to S1122.

The codec 112 may decode the encoded bitstream ENCODED BITSTREAM 3 stored in the encoded bitstream buffer address with reference to the last input data INPUT DATA 3 stored in the processor 113 at step S1127, write the decoded picture DECODED PICTURE 3 in the DPB 340 with reference to the input data INPUT DATA 3 at step S1128, and write the output data OUTPUT DATA 3 related to the decoded picture DECODED PICTURE 3 in the output data buffer 330 at step S1129.

At step S1130, the codec 112 may finish decoding with respect to the plurality of input data INPUT DATA 0 to 3, and transmit an interrupt signal INTERRUPT C30 to the processor 113. When compared to the example of FIG. 5, in an image processing device according to the present disclosure, since the codec 112 transmits one interrupt signal INTERRUPT C30 after finishing the decoding with respect to the plurality of input data INPUT DATA 0 to 3, the overhead for the processor 113 to process the plurality of interrupt signals INTERRUPT C0 to C3 transmitted by the codec 112 as the decoding of the plurality of input data INPUT DATA 0 to 3 is finished may be reduced.

At step S1131, the processor 113 may receive the interrupt signal INTERRUPT C30, and transmit the power-OFF signal to the codec 112.

Although the implementations of the present disclosure have been described in detail above, the scope of the present disclosure is not limited thereto, and various modifications and improvements of those skilled in the art using the basic concept of the present disclosure defined in the following claims are also included in the scope of the present disclosure, that fall within the scope of the right.

In some implementations, each component or combination of two or more components described with reference to FIG. 1 to FIG. 11 may be a digital circuit, a programmable or non-programmable logic device or array, or an application specific integrated circuit (ASIC), or the like.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

Although the implementations of the present disclosure have been described in detail above, the scope of the present disclosure is not limited thereto, and various modifications and improvements of those skilled in the art using the basic concept of the present disclosure defined in the following claims are also included in the scope of the present disclosure that fall within the scope of the right.

What is claimed is:

1. An image processing method, comprising:
performing an image processing operation with respect to a plurality of input data stored in an input data buffer; and
based on performing the image processing operation being finished, transmitting an interrupt signal, the interrupt signal indicating that the image processing operation with respect to the plurality of input data has been finished.

2. The image processing method of claim 1, comprising based on the plurality of input data being stored in the input data buffer, receiving a power-ON signal.

3. The image processing method of claim 2, comprising based on the power-ON signal being received, receiving information with respect to the number of the plurality of input data stored in the input data buffer.

4. The image processing method of claim 3, wherein performing the image processing operation comprises for each input data of the plurality of input data,
reading the input data from a base address of the input data buffer; and
generating an output data with reference to the input data.

5. The image processing method of claim 4, wherein:
the input data comprises information with respect to an encoded bitstream buffer address; and
the output data comprises a decoded picture obtained based on performing decoding with respect to encoded bitstream stored in the encoded bitstream buffer address.

6. The image processing method of claim 3, comprising determining, based on information of the number of the plurality of input data, whether performing the image processing operation with respect to the plurality of input data has been finished.

7. The image processing method of claim 1, comprising before the plurality of input data is stored in the input data buffer, receiving a power-ON signal.

8. The image processing method of claim 7, wherein performing the image processing operation comprises:
receiving the interrupt signal, the interrupt signal indicating a start of decoding of a first input data of the plurality of input data;
reading the first input data from a base address of the input data buffer based on a value of a count resistor being increased; and
generating a first output data with reference to the first input data.

9. The image processing method of claim 1, comprising receiving a power-OFF signal based on the interrupt signal.

10. A system-on-chip, comprising:
a processor configured to store a plurality of input data in an input data buffer; and
a codec configured to
perform an image processing operation with respect to the plurality of input data, and
based on performing the image processing operation with respect to the plurality of input data being finished, transmit an interrupt signal to the processor, the interrupt signal indicating that the image processing operation with respect to the plurality of input data has been finished.

11. The system-on-chip of claim 10, wherein the processor is configured to
store the plurality of input data in the input data buffer, and
apply a power-ON signal to the codec.

12. The system-on-chip of claim 11, wherein the processor is configured to transmit information of the number of the plurality of input data stored in the input data buffer to the codec.

13. The system-on-chip of claim 12, wherein for each input data of the plurality of input data, the codec is configured to
read the input data from a base address of the input data buffer, and
generate an output data with reference to the input data.

14. The system-on-chip of claim 13, wherein:
the input data comprises information with respect to an encoded bitstream buffer address; and
the output data comprises a decoded picture obtained based on performing decoding with respect to encoded bitstream stored in the encoded bitstream buffer address.

15. The system-on-chip of claim 12, wherein the codec is configured to determine, based on information of the number of the plurality of input data, whether performing the image processing operation with respect to the plurality of input data has been finished.

16. The system-on-chip of claim 10, wherein the processor is configured to apply a power-ON signal to the codec before the plurality of input data is stored in the input data buffer.

17. The system-on-chip of claim 16, wherein:
based on storing a first input data of the plurality of input data is finished, the processor is configured to
increase a value of a count resistor of the codec, and
transmit the interrupt signal to the codec, the interrupt signal indicating a start of decoding of the first input data; and
the codec is configured to
receive the interrupt signal, and
based on the value of the count resistor being increased, read the first input data from a base address of the input data buffer and generate a first output data with reference to the first input data.

18. The system-on-chip of claim 10, wherein the processor is configured to
receive the interrupt signal, and
apply a power-OFF signal to the codec.

19. An image processing device, comprising:
a working memory comprising an input data buffer and an output data buffer; and
a system-on-chip configured to
store a plurality of input data in the input data buffer, and
based on storing the plurality of input data being finished,
perform an image processing operation with respect to the plurality of input data,
store a plurality of output data corresponding to the plurality of input data in the output data buffer, and
generate an interrupt signal.

20. The image processing device of claim 19, wherein the number of the plurality of input data is greater than the number of the interrupt signals.
